(19) United States
(12) Patent Application Publication
(10) Pub. No.: US 2024/0275222 A1
(43) Pub. Date: Aug. 15, 2024

(54) STATOR AND ELECTRIC MOTOR INCLUDING THE SAME

(71) Applicant: TOYOTA JIDOSHA KABUSHIKI KAISHA, Toyota-shi (JP)

(72) Inventors: Yasuhiro MAKIDO, Toyota-shi (JP); Yuichiro KANADA, Toyota-shi (JP); Shogo KAJIMOTO, Toyota-shi (JP); Hideyuki HIGASHI, Okazaki-shi (JP); Yukio TSUCHIYA, Toyota-shi (JP)

(73) Assignee: TOYOTA JIDOSHA KABUSHIKI KAISHA, Toyota-shi (JP)

(21) Appl. No.: 18/410,269

(22) Filed: Jan. 11, 2024

(30) Foreign Application Priority Data
Feb. 9, 2023 (JP) 2023-018188

(51) Int. Cl. H02K 1/20; H02K 5/20

(52) U.S. Cl. CPC H02K 1/20; H02K 5/20; H02K 2213/03

(57) ABSTRACT

A stator may include a back iron having a cylindrical shape and extending along an axial direction; a plurality of teeth provided on an inner circumferential surface of the back iron; and a stator coil provided on the plurality of teeth. A plurality of coolant passages may be arranged in a circumferential direction in circumferential regions of the back iron and the plurality of coolant passages may extend along the axial direction to a first end face of the back iron. The plurality of coolant passages may include a coolant passage located in an uppermost portion of the back iron in a vertical direction and a coolant passage located in a lowermost portion of the back iron in the vertical direction. At the first end face of the back iron, an arrangement of the plurality of coolant passages may have two-fold symmetry and may not have four-fold symmetry.

### REFERENCE TO RELATED APPLICATION

This application claims priority to Japanese Patent Application No. 2023-018188 filed on Feb. 9, 2023. The entire content of the priority application is incorporated herein by reference.

### BACKGROUND ART

The technology disclosed herein relates to a stator and an electric motor including the same.

A stator for an electric motor is described in International Publication No. 2022/195920. This stator includes a back iron having a cylindrical shape and extending along an axial direction, a plurality of teeth provided on an inner circumferential surface of the back iron, and a stator coil provided on the plurality of teeth. A plurality of coolant passages, which extend along the axial direction to an end face of the back iron, is circumferentially arranged in the back iron. A coolant flowing in the coolant passages is supplied from the end face of the back iron to a coil end of the stator coil.

### DESCRIPTION

In the stator described above, the coolant passages are arranged over the entire circumference of the back iron. This configuration is excellent in cooling performance but may increase iron loss of the stator. In order to reduce iron loss of the stator, it is conceivable to reduce the number of the cooling passages. However, reducing the cooling passages may result in insufficient cooling performance and degradation in electromagnetic properties of the stator. In view of this, the disclosure herein provides a technology that ensures both cooling performance and electromagnetic properties of a stator.

The technology disclosed herein is embodied as a stator for an electric motor. The stator may comprise a back iron having a cylindrical shape and extending along an axial direction; a plurality of teeth provided on an inner circumferential surface of the back iron; and a stator coil provided on the plurality of teeth. The back iron may comprise a plurality of coolant passages. The plurality of coolant passages is arranged in a circumferential direction in circumferential regions of the back iron and the plurality of coolant passages may extend along the axial direction to a first end face of the back iron. The plurality of coolant passages may include a coolant passage located in an uppermost portion of the back iron in a vertical direction and a coolant passage located in a lowermost portion of the back iron in the vertical direction. At the first end face of the back iron, an arrangement of the plurality of coolant passages may have two-fold symmetry and does not have four-fold symmetry.

In the stator according to the present technology, the plurality of coolant passages is arranged in the back iron. The plurality of coolant passages extends along the axial direction to the first end face of the back iron. A coolant flowing in the coolant passages is supplied from the first end face of the back iron to a first coil end. The first coil end is thus cooled by the coolant. The first coil end herein is an end portion of the stator coil protruding from the first end face of the back iron. In the stator according to the present technology, the plurality of cooling passages is disposed only in partial regions in the circumferential direction of the back iron. Since the plurality of coolant passages is reduced in number as compared to conventional configurations, iron loss of the stator is reduced.

This reduction of the cooling passages, however, may result in insufficient cooling for the first coil end. In this regard, according to the present technology, at least one cooling passage is located in each of the uppermost portion and the lowermost portion of the back iron in the vertical direction. This configuration allows for an efficient coolant supply to the first coil end. Specifically, after supplied from the coolant passages to the first coil end, the coolant cools the first coil end while flowing downward by its own weight. Owing to the coolant passage in the uppermost portion of the back iron, the coolant can be supplied to an uppermost portion of the first coil end and then reach the entirety of the coil end. However, since the temperature of coolant is already increased by the time it reaches a lowermost portion of the first coil end, the coolant may not be able to sufficiently absorb heat. In this regard, the coolant can be directly supplied to the lowermost portion of the first coil end from the coolant passage in the lowermost portion of the back iron, and thus cooling for the lowermost portion of the first coil end can be improved.

The reduction of the cooling passages may also result in degradation in electromagnetic properties of the stator. In this regard, in the stator according to the present technology, the arrangement of the plurality of coolant passages has two-fold symmetry and does not have four-fold symmetry. In other words, as compared to conventional configurations, the stator is devoid of four-fold symmetry as a result of the reduction of the coolant passages but maintains two-fold symmetry. With two-fold symmetry maintained, the arrangement of the plurality of coolant passages maintains its symmetry in at least two perpendicular directions (e.g., in up-down direction and right-left direction). Thus, the symmetry of electromagnetic properties required for the stator is maintained, and thus for example, induced oscillation of the rotor can be avoided.

### BRIEF DESCRIPTION OF DRAWINGS

FIG. 1 is a schematic cross-sectional view of an electric motor 2 according to an embodiment.

FIG. 2 is a cross-sectional view along a line II-II in FIG. 1.

FIG. 3 is a cross-sectional view along a line III-III in FIG. 1.

FIG. 4 is a cross-sectional view along a line IV-IV in FIG. 1, where details of teeth 14 and a stator coil 16 are omitted.

FIG. 5 is a partial cross-sectional view showing stator cores 12, 14 individually.

FIG. 6 is a cross-sectional view corresponding to FIG. 2, showing features of an electric motor 102 according to another embodiment.

FIG. 7 is a cross-sectional view corresponding to FIG. 2, showing features of an electric motor 202 according to another embodiment.

### DETAILED DESCRIPTION

In one or more aspects of the present technology, the plurality of coolant passages may comprise a plurality of first coolant passages disposed in a first circumferential region of the back iron and a plurality of second coolant passages disposed in a second circumferential region of the back iron. In this case, the first circumferential region may include the uppermost portion and the second circumferential region may include the lowermost portion.

In one or more aspects of the present technology, the uppermost portion may be located in a center of the first circumferential region and the lowermost portion may be located in a center of the second circumferential region. In this case, each of the first and second circumferential regions is a region expanding symmetrically in a horizontal direction.

In one or more aspects of the present technology, each of the first circumferential region and the second circumferential region may be a region of 120 degrees or less in the circumferential direction.

In one or more aspects of the present technology, each of the first circumferential region and the second circumferential region may be a region of 45 degrees or less in the circumferential direction.

In one or more aspects of the present technology, none of the plurality of coolant passages may be disposed in a third circumferential region and a fourth circumferential region of the back iron, and each of the third circumferential region and the fourth circumferential region is adjacent to the first circumferential region and the second circumferential region.

In one or more aspects of the present technology, the plurality of coolant passages may be at least partially formed of a plurality of through holes defined in the back iron. In another embodiment, the plurality of coolant passages may be at least partially formed of a plurality of grooves defined in an outer circumferential surface of the back iron.

In one or more aspects of the preset technology, the back iron may comprise an annular coolant passage extending in the circumferential direction and connected to each of the plurality of coolant passages. This configuration allows the coolant to flow from the annular coolant passage to each of the plurality of coolant passages.

In one or more aspects of the present technology, the annular coolant passage may be formed of a groove defined in an outer circumferential surface of the back iron.

In one or more aspects of the present technology, the stator may further comprise a casing surrounding an outer circumferential surface of the back iron. The casing may comprise a coolant supply hole connected to the annular coolant passage and the coolant supply hole may be located at an intermediate position of the annular coolant passage in the vertical direction. This configuration allows the coolant supplied through the coolant supply hole into the annular coolant passage to flow separate ways, more specifically, upward and downward, in the annular coolant passage, and thus the coolant is efficiently delivered to each of the plurality of coolant passages.

In one or more aspects of the present technology, the stator may further comprise a first annular member disposed on the first end face of the back iron. The first annular member may comprise a plurality of first coolant injection holes that are directed toward a first coil end of the stator coil protruding from the first end face. This configuration allows the coolant to be injected from the plurality of coolant passages toward the first coil end.

In one or more aspects of the present technology, the plurality of coolant passages may extend along the axial direction to a second end face of the back iron located opposite the first end face. This configuration allows the coolant to be supplied to a second coil end of the stator coil protruding from the second end face of the back iron.

In one or more aspects of the present technology, the stator may further comprise a second annular member disposed on the second end face of the back iron. The second annular member may comprise a plurality of second coolant injection holes that are directed toward a second coil end of the stator coil protruding from the second end face. This configuration allows the coolant to be injected from the plurality of coolant passages toward the second coil end.

The technology disclosed herein is also embodied as an electric motor. The electric motor may comprise a stator and a rotor disposed within the stator. In this case, the stator may be a stator according to any aspect disclosed herein.

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved stators for electric motors and electric motors, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Referring to the drawings, a stator 10 according to an embodiment and an electric motor 2 including the stator 10 are described. The electric motor 2 can be used in an electric-powered vehicle as a prime mover for driving the wheel(s), but the application is not particularly limited thereto. The electric-powered vehicle herein broadly means any vehicle that includes a motor for driving at least one wheel and comprises, for example, a battery electric-powered vehicle, a hybrid electric-powered vehicle, a plug-in hybrid electric-powered vehicle, and a fuel cell electric-powered vehicle.

In the drawings, a direction X and a direction Y are horizontal directions and are perpendicular to each other, and a direction Z is a vertical direction and is perpendicular to the directions X and Y. The direction X is parallel to a center axis C of the electric motor 2 and may be referred to as an axial direction X herein. Further, a direction R in the drawings indicates a circumferential direction R about the center axis C of the electric motor 2. Moreover, unlabeled arrows in the drawings schematically show how a coolant flows.

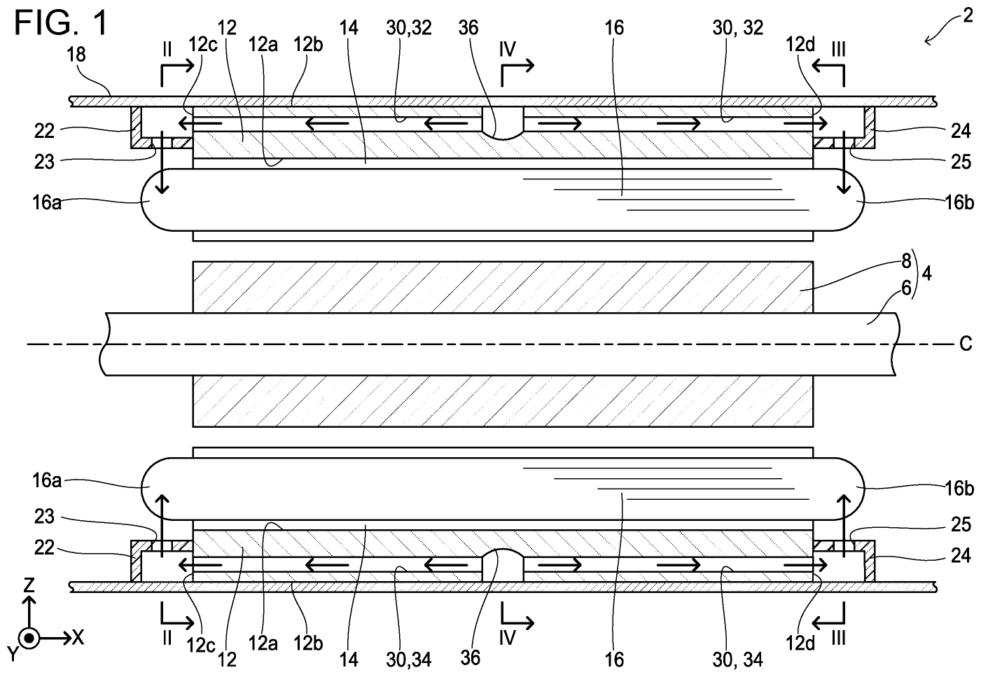

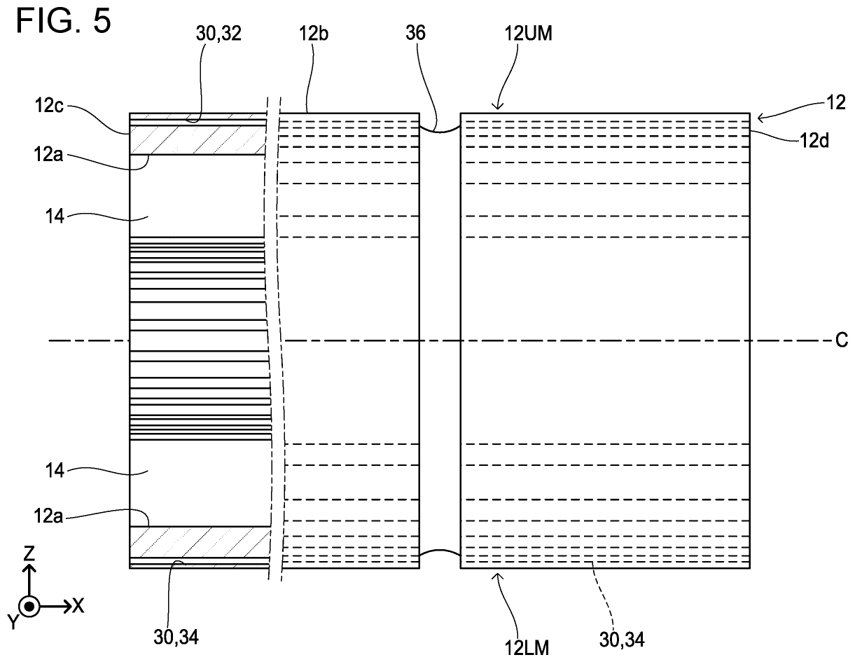

As shown in FIGS. 1 to 5, the electric motor 2 comprises a rotor 4 and the stator 10. The rotor 4 is disposed within the stator 10 and is supported rotatably about the center axis C. The rotor 4 comprises a center shaft 6 and a rotor core 8 fixed to the center shaft 6. The rotor core 8 is constituted of a soft magnetic material. The rotor core 8 in the present embodiment is formed of a stack of magnetic steel sheets, although this is merely an example. A plurality of permanent magnets (not shown) is arranged on/in the rotor core 8 along the circumferential direction R.

The stator 10 comprises a stator core 12, 14, a stator coil 16, and a casing 18. The stator core 12, 14 is constituted of a soft magnetic material. The stator core 12, 14 in the present embodiment is formed of a stack of magnetic steel sheets, although this is merely an example. The stator core 12, 14 comprises a back iron 12 that has a cylindrical shape and extends along the axial direction X and a plurality of teeth 14 provided on an inner circumferential surface 12a of the back iron 12. The teeth 14 are equally spaced apart from each other in the circumferential direction R. Each of the teeth 14 protrudes from the inner circumferential surface 12a of the back iron 12 toward the center axis C. In some of the drawings, a part or entirety of the plurality of teeth 14 is omitted. The casing 18 is disposed to surround an outer circumferential surface 12b of the back iron 12.

The stator coil 16 is provided on the plurality of teeth 14. Although details are omitted in the drawings, the stator coil 16 is a collectivity of multiple coils and each of these coils is arranged to surround corresponding one or more teeth 14. The stator coil 16 may be constituted of flexible wires or rigid rectangular wires. The specific structure of the stator coil 16 is not limited. Both ends 16a, 16b of the stator coil 16 in the axial direction X protrude from the stator core 12, 14. In the disclosure herein, one end 16a of the stator coil 16 in the axial direction X is termed a first coil end 16a, and the other end 16b of the stator coil 16 in the axial direction X is termed a second coil end 16b.

A plurality of cooling passages 30 is defined in the back iron 12. The coolant passages 30 are arranged along the circumferential direction R near the outer circumferential surface 12b of the back iron 12. Each of the coolant passages 30 extends in the axial direction X and reaches a first end face 12c and a second end face 12d of the back iron 12 in the axial direction. The specific configuration of the plurality of coolant passages 30 is not limited. For example, each coolant passage 30 may have a cross-sectional shape of rectangle, circle, or another shape. The coolant passages 30 may be arranged in two or more rows along the circumferential direction R. The coolant passages 30 are passages in which a coolant flows. The coolant herein means a heat medium for cooling purposes, particularly a liquid oil.

The coolant passages 30 are located only in regions A1, A2 of the back iron 12 in the circumferential direction R. That is, the plurality of coolant passages 30 comprises a plurality of first coolant passages 32 located in a first region A1 of the back iron 12 in the circumferential direction R and a plurality of second coolant passages 34 located in a second region A2 of the back iron 12 in the circumferential direction R. The first region A1 includes an uppermost portion 12UM of the back iron 12 in the vertical direction, and the second region A2 includes a lowermost portion 12LM of the back iron 12 in the vertical direction. On the other hand, none of the coolant passages 30 is located in a third region A3 and a fourth region A4 of the back iron 12 in the circumferential direction R. Each of the third region A3 and the fourth region A4 is interposed between the first region A1 and the second region A2 and is adjacent to the first region A1 and the second region A2. The third region A3 and the fourth region A4 are opposite to each other in a horizontal direction with the center axis C interposed therebetween.

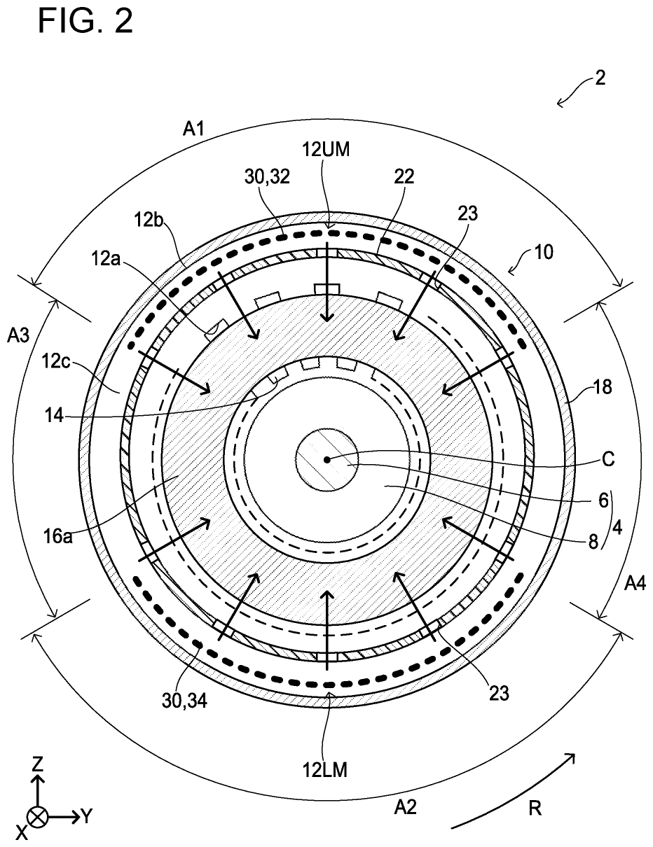

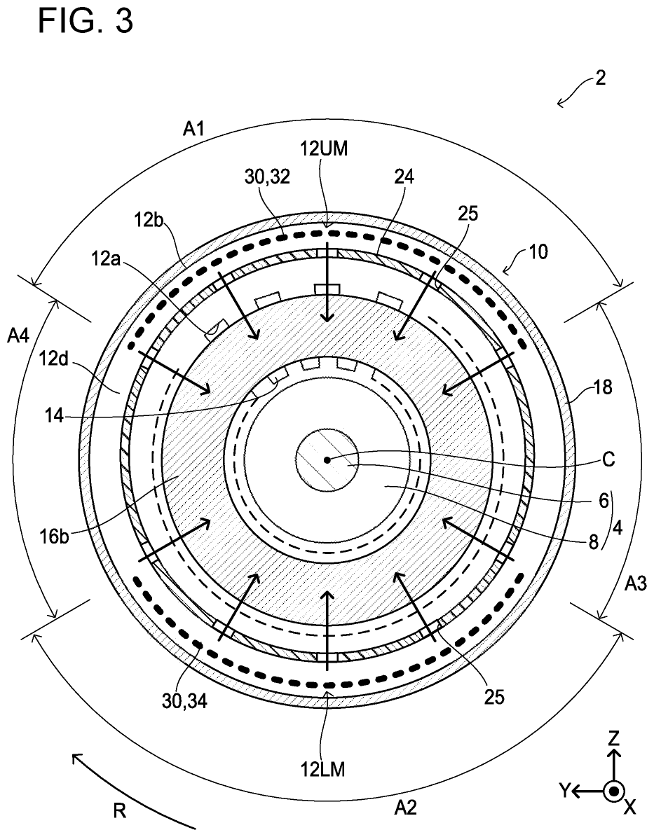

The first region A1 and the second region A2 described above have the same angular range in the circumferential direction R and are symmetric with respect to the center axis C. Thus, at the first end face 12c of the back iron 12, the arrangement of the coolant passages 30 has two-fold symmetry and does not have four-fold symmetry (see FIG. 2). Similarly, as shown in FIG. 3, at the second end face 12d of the back iron 12, the arrangement of the coolant passages 30 has two-fold symmetry and does not have four-fold symmetry (see FIG. 3).

Each of the first region A1 and the second region A2 may be a region of 120 degrees or less. Alternatively, each of the first region A1 and the second region A2 may be a region of 90 degrees or less. Alternatively, each of the first region A1 and the second region A2 may be a region of 45 degrees or less. The first region A1 and the second region A2 shown in FIG. 1 are each a region of 120 degrees or less in the circumferential direction R, although this is merely an example.

The first region A1 may be centered around the uppermost portion 12UM of the back iron 12, although this is merely an example. That is, the uppermost portion 12UM may be located in the center of the first region A1 and the first region A1 may expand symmetrically from the uppermost portion 12UM in the horizontal direction. Similarly, the second region A2 may be centered around the lowermost portion 12LM of the back iron 12. That is, the lowermost portion 12LM may be located in the center of the second region A2 and the second region A2 may expand symmetrically from the lowermost portion 12LM in the horizontal direction.

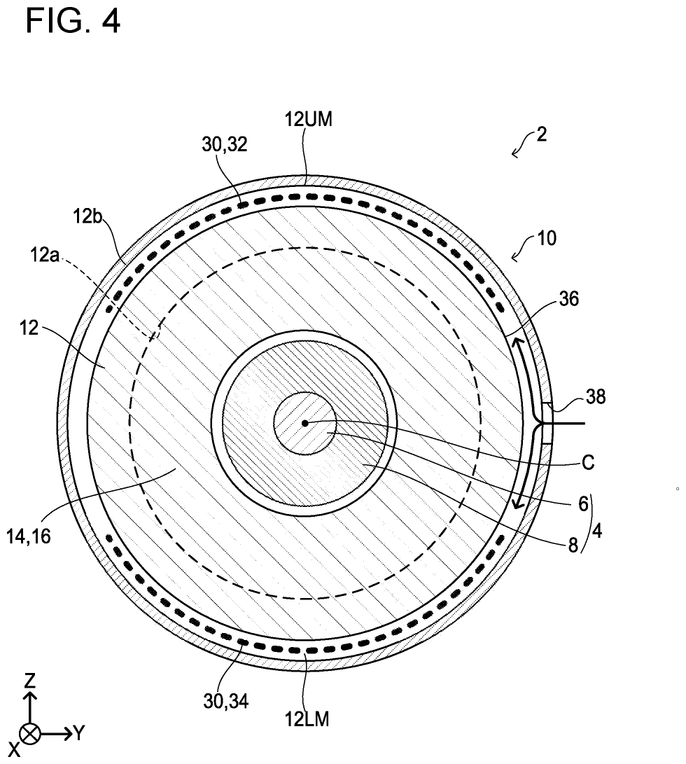

An annular coolant passage 36 extending in the circumferential direction R is defined in the outer circumferential surface 12b of the back iron 12. The annular coolant passage 36 is located at an intermediate position of the back iron 12 in the axial direction X and is connected to each of the plurality of coolant passages 30. Further, the casing 18 comprises a coolant supply hole 38 that is connected to the annular coolant passage 36 and is located at an intermediate position of the casing 18 in the vertical direction. This allows the coolant to be supplied from the outside of the casing 18 through the coolant supply hole 38 into the annular coolant passage 36. Once supplied into the annular coolant passage 36, the coolant flows separate ways, upward and downward, along the annular coolant passage 36 (see FIG. 4) and reaches each of the coolant passages 30. Particularly, since the coolant supply hole 38 is located apart from the plurality of first coolant passages 32 and the plurality of second coolant passages 34, the coolant is distributed in a balanced manner to each of the first coolant passages 32 and the second coolant passages 34. The coolant supply hole 38 in the present embodiment is located on the same horizontal plane on which the center axis C is located and is equidistant from the plurality of first coolant passages 32 and the plurality of second coolant passages 34, although this is merely an example.

The stator 10 further comprises a first annular member 22 and a second annular member 24. The first annular member 22 extends annularly along the circumferential direction R and is constituted of, for example, a resin material. The first annular member 22 is provided on the first end face 12c of the back iron 12. The first annular member 22 extends from the first end face 12c of the back iron 12 to the casing 18. The first annular member 22 includes a plurality of first coolant injection holes 23. The first coolant injection holes 23 are arranged along the circumferential direction R and are each directed toward the first coil end 16a. The coolant flowing in the plurality of coolant passages 30 is injected through the plurality of first coolant injection holes 23 of the first annular member 22 toward the first coil end 16a. The first coil end 16a is thereby cooled by the coolant. The first annular member 22 is not necessarily essential. That is, the coolant flowing in the plurality of coolant passages 30 may be directly supplied from the first end face 12c of the back iron 12 to the first coil end 16a.

The second annular member 24 extends annularly along the circumferential direction R and is constituted of, for example, a resin material. The second annular member 24 is provided on the second end face 12d of the back iron 12. The second annular member 24 extends from the second end face 12d of the back iron 12 to the casing 18. The second annular member 24 includes a plurality of second coolant injection holes 25. The second coolant injection holes 25 are arranged along the circumferential direction R and are each directed toward the second coil end 16b. The coolant flowing in the plurality of coolant passages 30 is injected through the plurality of second coolant injection holes 25 of the second annular member 24 toward the second coil end 16b. The second coil end 16b is thereby cooled by the coolant. The second annular member 24 is not necessarily essential either. That is, the coolant flowing in the plurality of coolant passages 30 may be directly supplied from the second end face 12d of the back iron 12 to the second coil end 16b.

As described above, in the stator 10 of the present embodiment, the plurality of coolant passages 30 is defined in the back iron 12. The plurality of coolant passages 30 extends along the axial direction X to the first end face 12c and the second end face 12d of the back iron 12. The coolant flowing in the coolant passages 30 is supplied from the first end face 12c of the back iron 12 to the first coil end 16a and from the second end face 12d of the back iron 12 to the second coil end 16b. Thus, the first coil end 16a and the second coil end 16b are cooled by the coolant.

In the stator 10 of the present embodiment, the coolant passages 30 are disposed only in the circumferential regions A1, A2 of the back iron 12. Contrary to this, in conventional configurations, the coolant passages 30 are disposed over the entire circumference of the back iron 12. Since the coolant passages 30 is reduced as compared to the conventional configurations, iron loss in the stator 10 (especially in the back iron 12) is reduced. However, this reduction of the coolant passages 30 may result in insufficient cooling for the first coil end 16a and the second coil end 16b. With regard to this, in the stator 10 of the present embodiment, at least one coolant passage 30 is disposed in each of the uppermost portion 12UM of the back iron 12 in the vertical direction and the lowermost portion 12LM of the back iron 12 in the vertical direction.

The above configuration allows the coolant to be efficiently supplied to the first coil end 16a and the second coil end 16b. That is, the coolant supplied to the first coil end 16a from the coolant passages 30 cools the first coil end 16a while flowing downward under its own weight. Owing to the at least one coolant passage 30 disposed in the uppermost portion 12UM of the back iron 12, the coolant can be supplied to an uppermost portion of the first coil end 16a and reach all over the first coil end 16a. However, since the temperature of the coolant is already increased when the coolant reaches a lowermost portion of the first coil end 16a, the coolant may not be able to absorb sufficient heat there. In view of this, at least one coolant passage 30 is also disposed in the lowermost portion 12LM of the back iron 12 to directly supply the coolant to the lowermost portion of the first coil end 16a, so that cooling for the lowermost portion of the first coil end 16a is facilitated. The same applies to the second coil end 16b, and thus the description is not duplicated for the second coil end 16b.

The reduction of the coolant passages 30 may also result in degradation in electromagnetic properties of the stator 10. In this regard, in the stator 10 according to the present embodiment, the arrangement of the plurality of coolant passages 30 has two-fold symmetry and does not have four-fold symmetry. In other words, as compared to conventional configurations, the stator 10 is devoid of four-fold symmetry as a result of the reduction of the coolant passages 30 but maintains two-fold symmetry. With two-fold symmetry maintained, the arrangement of the plurality of coolant passages 30 maintains its symmetry in at least two perpendicular directions (e.g., in the Z direction and the Y direction). Thus, the symmetry of electromagnetic properties required for the stator 10 is maintained, and thus for example, induced oscillation of the rotor 4 can be avoided.

In the stator 10 according to the present embodiment, the plurality of coolant passages 30 is formed of a plurality of through holes defined in the back iron 12. However, in another embodiment, a part or all of the plurality of coolant passages 30 may be formed of one or more grooves defined in the outer circumferential surface 12b of the back iron 12. That is, a part or all of the plurality of coolant passages 30 may be formed of one or more spaces defined between the one or more grooves in the back iron 12 and the casing 18. In the present embodiment, the annular coolant passage 36 is formed of a groove defined in the outer circumferential surface 12b of the back iron 12. However, in another embodiment, the annular coolant passage 36 may be formed of one or more through holes defined in the back iron 12. The number of the annular coolant passage 36 and the position thereof in the axial direction X are not particularly limited.

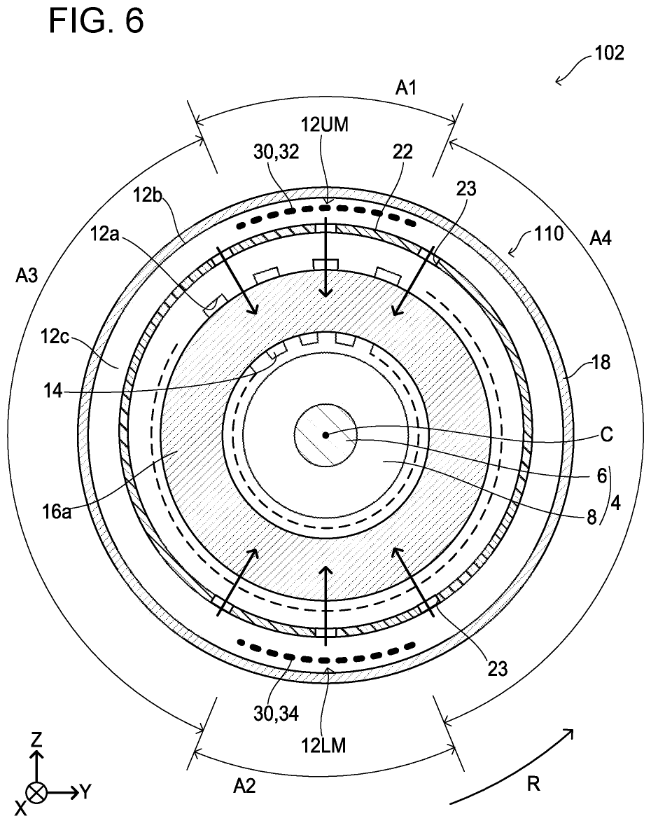

In the stator 10 according to the present embodiment, each of the first region A1 and the second region A2 is a region of 120 degrees in the circumferential direction R. However, as shown in FIG. 6, in a stator 110 according to another embodiment and an electric motor 102 comprising the same, each of the first region A1 and the second region A2 may be a region of 45 degrees or less in the circumferential direction R. In this case as well, the first region A1 may be centered around the uppermost portion 12UM of the back iron 12 and the second region A2 may be centered around the lowermost portion 12LM of the back iron 12. In the embodiment shown in FIG. 6, each of the first region A1 and the second region A2 is smaller than both of the third region A3 and the fourth region A4. This configuration can significantly reduce iron loss in the stator 110 because the number of the coolant passages 30 is significantly reduced.

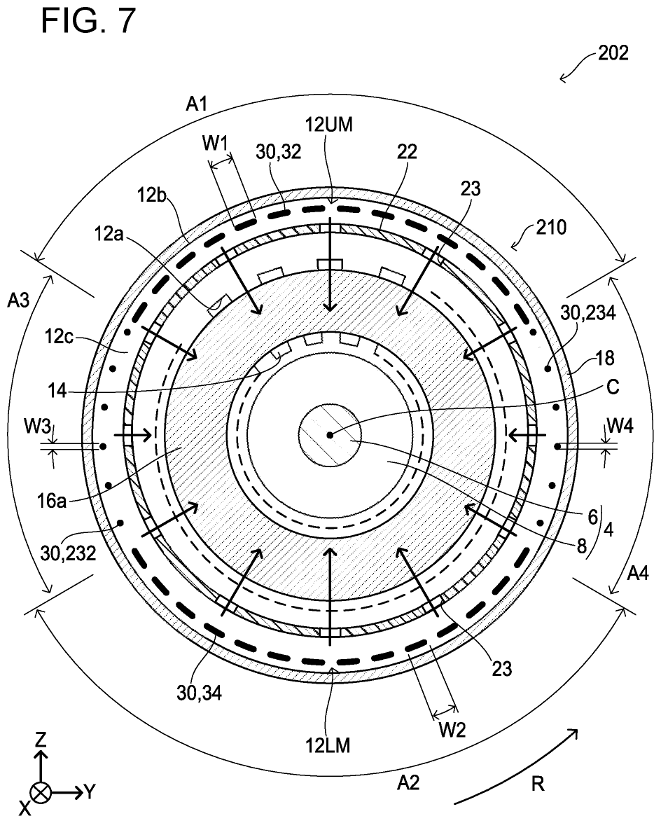

In the stators 10, 110 described above, the coolant passages 30 are disposed only in the first region A1 and the second region A2 and none of them is disposed in the third region A3 and the fourth region A4. However, as shown in FIG. 7, in a stator 210 according to another embodiment and an electric motor 202 comprising the same, a part of the plurality of coolant passages 30 is disposed in each of the third region A3 and the fourth region A4. That is, the plurality of coolant passages 30 further comprises a plurality of third coolant passages 232 disposed in the third region A3 and a plurality of fourth coolant passages 234 disposed in the fourth region A4. The plurality of third coolant passages 232 and the plurality of fourth coolant passages 234 are arranged symmetrically with respect to the center axis C. Thus, at the first end face 12c of the back iron 12, the arrangement of the coolant passages 30 has two-fold symmetry and does not have four-fold symmetry.

A dimension W1 of the first coolant passages 32 in the circumferential direction R is larger than a dimension W3 of the third coolant passages 232 in the circumferential direction R and a dimension W4 of the fourth coolant passages 234 in the circumferential direction R. Further, a dimension W2 of the second coolant passages 34 in the circumferential direction R is larger than the dimension W3 of the third coolant passages 232 in the circumferential direction R and the dimension W4 of the fourth coolant passages 234 in the circumferential direction R. The dimension W1 of the first coolant passages 32 in the circumferential direction R is equal to the dimension W2 of the second coolant passages 34 in the circumferential direction R, and the dimension W3 of the third coolant passages 232 in the circumferential direction R is equal to the dimension W4 of the fourth coolant passages 234 in the circumferential direction R. Intervals between the coolant passages 30 in the circumferential direction R are constant in the four regions A1 to A4.

The above configuration also allows the coolant to be preferentially supplied in a larger amount to the uppermost portion of the first coil end 16a and the lowermost portion of the first coil end 16a, and thus can efficiently cool the first coil end 16a. The same applies to the second coil end 16b. Further, since the coolant passages 30 are reduced in the third region A3 and the fourth region A4 of the back iron 12 as compared to the first region A1 and the second region A2, iron loss in the stator 210 (especially in the back iron 12) can be reduced.

In addition to or instead of the above, a dimension of the first coolant passages 32 in a radial direction and a dimension of the second coolant passages 34 in the radial direction may be larger than a dimension of the third coolant passages 232 in the radial direction and a dimension of the fourth coolant passages 234 in the radial direction. The radial direction herein means a direction perpendicular to both the axial direction X and the circumferential direction R. Additionally or alternatively, intervals between the first coolant passages 32 in the circumferential direction and intervals between the second coolant passages 34 in the circumferential direction may be smaller than intervals between the third coolant passages 232 in the circumferential direction and intervals between the fourth coolant passages 234 in the circumferential direction. In all of such configurations, a volumetric occupancy of the first coolant passages 32 in the first region A1 and a volumetric occupancy of the second coolant passages 34 in the second region A2 are larger than a volumetric occupancy of the third coolant passages 232 in the third region A3 and a volumetric occupancy of the fourth coolant passages 234 in the fourth region A4. With this relationship satisfied, the coolant can be preferentially supplied in a larger amount to the uppermost portions and the lowermost portions of the coil ends 16a, 16b. That is, the coil ends 16a, 16b can be efficiently cooled.

What is claimed is:

1. A stator for an electric motor, comprising:
a back iron having a cylindrical shape and extending along an axial direction;
a plurality of teeth provided on an inner circumferential surface of the back iron; and
a stator coil provided on the plurality of teeth,
wherein
the back iron comprises a plurality of coolant passages that is arranged in a circumferential direction in circumferential regions of the back iron, the plurality of coolant passages extending along the axial direction to a first end face of the back iron,
the plurality of coolant passages includes a coolant passage located in an uppermost portion of the back iron in a vertical direction and a coolant passage located in a lowermost portion of the back iron in the vertical direction, and
at the first end face of the back iron, an arrangement of the plurality of coolant passages has two-fold symmetry and does not have four-fold symmetry.

2. The stator according to claim 1, wherein
the plurality of coolant passages comprises:
a plurality of first coolant passages disposed in a first circumferential region of the back iron;
a plurality of second coolant passages disposed in a second circumferential region of the back iron, and
the first circumferential region includes the uppermost portion and the second circumferential region includes the lowermost portion.

3. The stator according to claim 2, wherein the uppermost portion is located at a center of the first circumferential region and the lowermost portion is located in a center of the second circumferential region.

4. The stator according to claim 2, wherein each of the first circumferential region and the second circumferential region is a region of 120 degrees or less in the circumferential direction.

5. The stator according to claim 4, wherein each of the first circumferential region and the second circumferential region is a region of 45 degrees or less in the circumferential direction.

6. The stator according to claim 2, wherein none of the plurality of coolant passages is disposed in a third circumferential region and a fourth circumferential region of the back iron, each of the third circumferential region and the fourth circumferential region is adjacent to the first circumferential region and the second circumferential region.

7. The stator according to claim 1, wherein the plurality of coolant passages is at least partially formed of a plurality of through holes defined in the back iron.

8. The stator according to claim 1, wherein the back iron comprises an annular coolant passage extending in the circumferential direction and connected to each of the plurality of coolant passages.

9. The stator according to claim 8, wherein the annular coolant passage is formed of a groove defined in an outer circumferential surface of the back iron.

10. The stator according to claim 8, further comprising a casing surrounding an outer circumferential surface of the back iron,
wherein the casing comprises a coolant supply hole connected to the annular coolant passage, the coolant supply hole located at an intermediate position of the annular coolant passage in the vertical direction.

11. The stator according to claim 1, further comprising a first annular member disposed on the first end face of the back iron,
wherein the first annular member comprises a plurality of first coolant injection holes that are directed toward a first coil end of the stator coil protruding from the first end face.

12. The stator according to claim 1, wherein the plurality of coolant passages extends along the axial direction to a second end face of the back iron located opposite the first end face.

13. The stator according to claim 12, further comprising a second annular member disposed on the second end face of the back iron,
wherein the second annular member comprises a plurality of second coolant injection holes that are directed toward a second coil end of the stator coil protruding from the second end face.

14. An electric motor comprising:
the stator according to claim 1; and
a rotor disposed within the stator.
